(19) United States
(12) Patent Application Publication
(10) Pub. No.: US 2026/0211111 A1
(43) Pub. Date: Jul. 23, 2026

(54) ADAPTIVE ULTRASOUND BEAMFORMING

(71) Applicant: UNIVERSITY OF LEEDS, Leeds (GB)

(72) Inventors: Elliott Ian James SMITH, Leeds (GB); Steven FREEAR, Leeds (GB)

(73) Assignee: UNIVERSITY OF LEEDS, Leeds, EN (GB)

(21) Appl. No.: 19/136,286

(22) PCT Filed: Dec. 7, 2023
(86) PCT No.: PCT/IB2023/000713

§ 371 Date: Jun. 6, 2025

(30) Foreign Application Priority Data
Dec. 6, 2022 (GB) 2218330.5

(51) Int. Cl. G01S 15/89; G01S 7/52

(52) U.S. Cl. CPC G01S 15/8977; G01S 7/52047; G01S 15/8915

(57) ABSTRACT

Ultrasound beamforming is performed by a deep learning architecture incorporating convolution layers and known operators. The network is trained to combine multiple observations of complex signal data in an optimal way into a single complex signal. This is achieved using convolutional layers with learnable parameters and by embedding and an operator to perform multiple weighted sum operations of subsets of the original observations and average these to produce a single complex signal. Known operators including a forward-backward operator are optionally incorporated into the architecture.

### FIELD OF TECHNOLOGY

The present disclosure relates to a method and system for performing adaptive ultrasound beamforming. In particular, the disclosure relates to a deep learning architecture for ultrasound beamforming, consisting of one or more neural networks. The or each network is trained to predict a set of apodization weights and perform the apodization within the architecture.

### BACKGROUND

Brightness mode (B-mode) ultrasound image reconstruction is performed using the magnitude (brightness) of ultrasound echoes from an insonified medium. The echo signals are measured with an array of sensors, known as elements. Each element converts a pressure wave into an electrical signal, typically through the application of the piezoelectric effect. This electrical signal is typically amplified and then digitised using an analog to digital converter (ADC) at a specified sampling rate. By a process known as beamforming, the data from these elements are combined to estimate the magnitude of the echo from a point in the medium. This is achieved by applying spatial filtering resulting in a beam pattern with local maxima, known as lobes, and minima. The common aim of all beamformers is to achieve a beam with a narrow main lobe (i.e. the lobe emitted in the direction of interest) and low sidelobe level (i.e. the undesired lobes outside of the region of interest).

A narrow main lobe ensures that the lateral resolution of the system is sufficient, this is achieved by applying focusing delays. Low sidelobes ensure that the interference from off axis scattering is minimised. Strong scatterers in the sidelobes can be misinterpreted as weak scatterers in the main lobe, which can limit lateral resolution. Sidelobes can be suppressed by applying element-wise weights in the beamformer, this is known as apodization. As the sidelobes are suppressed through apodization, the main lobe is made broader. The beamformer most widely adopted is the Delay and Sum (DaS) beamformer with a fixed apodization weighting. The inadequate lateral resolution of the DaS beamformer limits its usefulness for anatomical imaging of small deep structures.

Data-adaptive beamformers, such as those that utilise the Minimum Variance (MV) technique, can be adopted to improve the lateral resolution. In such beamformers, the optimal apodization is calculated based on the statistics of the received data. Thus, in regions containing strong interference, sidelobes are suppressed and in regions where there is not, the sidelobes are preserved. Such algorithms, however, are complex in nature and a real-time implementation remains a significant challenge.

Techniques such as sub-array averaging, in which multiple sub-arrays are used in the covariance matrix estimation, and temporal averaging, in which multiple temporal samples are used in the covariance matrix estimation, can be adopted to obtain a better estimation. Diagonal loading, in which a coefficient of the identity matrix is added to the sample covariance matrix, and forward backward averaging, in which the imaging array and the angle of arrival of the signal are flipped (backward aperture) and then subsequently averaged with the original (forward aperture), can be applied to increase the robustness in the presence of speed of sound estimation errors.

Furthermore, the non-stationary nature of ultrasound waves limits the number of samples of incoming data that can be used in the estimate of the statistics required to determine the optimal apodization. This ultimately limits the accuracy of the estimate.

Deep learning architectures can overcome some of the limitations of the Minimum Variance algorithm. The ability of a Deep Learning architecture to generalise to the vast quantities of statistics available in the dataset used for training may provide more accurate estimations of optimal apodization weights in the presence of noise or speed of sound estimation errors. Deep learning architectures can be efficiently implemented on Graphics Processing Units (GPUs) or Tensor Processing Units (TPUs). These devices often incorporate hardware acceleration designed to carry out common operations found in deep learning architectures, for instance convolution operations. Deep learning architectures often consist of large, generic, data driven models with many parameters. These types of models rely on vast datasets that sufficiently represent the inverse problem and a sufficiently large network to generalise well over a range of conditions. It is difficult to predict how these data-driven models will perform on unseen data. In addition, these networks can be inefficient in terms of computational complexity.

Reference to any prior art in this specification is not an acknowledgement or suggestion that this prior art forms part of the common general knowledge in any jurisdiction, or globally, or that this prior art could reasonably be expected to be understood, regarded as relevant/or combined with other pieces of prior art by a person skilled in the art.

It is an object of the invention to at least ameliorate one or more of the above or other shortcomings of prior art and/or to provide a useful alternative.

### SUMMARY OF THE INVENTION

The invention is a method and system as defined in the appended claims.

It will be appreciated that features and aspects of the present disclosure may be combined with other different aspects of the disclosure as appropriate, and not just in the specific illustrative combinations described herein.

According to an aspect of the disclosure, there is provided a method of generating beam formed ultrasound signals, the method comprising:
receiving a plurality of first electrical signals from respective ultrasound transducer elements, wherein each said ultrasound transducer element is adapted to generate a respective said first electrical signal in response to ultrasound received from a location in an object;
processing the first electrical signals, said processing including applying predetermined delay profiles;
inputting the processed first electrical signals into a trained artificial neural network, the trained artificial neural network including a plurality of convolutional layers;
determining, in the trained artificial neural network, apodization weights for beam forming the ultrasound signals; and
outputting, from the trained artificial neural network, a beam formed signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a respective said apodization weight, and each said sum is based on less than all of said processed first electrical signals.

By generating a beam formed signal representing the scattered ultrasound received from said location in said object on the basis of a plurality of second electrical signals, wherein each said second electrical signal is based on a respective sum of products, wherein each said product is a product of a respective first input based on a respective said first electrical signal and a respective second input based on a respective said apodization weight, and each said sum is based on less than all of said first electrical signals, this provides the advantage of reducing the effect of errors in the first electrical signals. This in turn enables the training time of the neural network to be reduced, and improves the quality of ultrasound image data obtained in the inference stage of the artificial neural network.

Training time reduction is due to the reduction in the number of trainable parameters, since the network incorporates known operators to replace what would otherwise be trainable layers. Moreover, for a given input size, the network of the present disclosure is arranged to predict fewer apodization weights than the input size, this allows compression through the network which can speed up inference in the prediction of apodization weights.

Improved image quality is made possible because the signal is artificially decorrelated. The assumption in Minimum Variance algorithms is that the desired signal is uncorrelated with the undesired signals. This is not the case for ultrasound imaging in which the interference is typically highly correlated. The covariance matrix can be calculated for several different subapertures. These can be averaged to decorrelate the coherent signals artificially, resulting in a better estimate for the covariance matrix. It can be used to avoid signal cancellation.

In addition, the artificial decorrelation of the present disclosure reduces the size of the covariance matrix as compared to a full-aperture and increases the number of observations. If the number of observations of the location is less than the number of elements of the subarray, the covariance matrix may not be invertible.

For example, the reduction of the effect of errors in the first electrical signals enables a covariance matrix used in a minimum variance technique for creating learning data for the artificial neural network to be invertible, thereby enabling a better estimate of the spatial covariance matrix to provide learning data for the artificial neural network, which in turn leads to improved image quality. The prediction of fewer apodization weights than the input size leads to a smaller network with fewer operations, improving throughput.

A plurality of said second electrical signals may be based on a respective plurality of said first electrical signals received from said location in the object at different times.

This provides the advantage of further reducing the effect of errors in the first electrical signals.

In certain embodiments, processing the first electrical signals may further include amplifying the first electrical signals and digitising the amplified first electrical signals and optionally, normalising the digitised first electrical signals and applying a Hilbert transform to the normalised signal.

The trained artificial neural network may, in certain cases, further include at least one beamforming operator layer. The at least one beamforming operator layer may optionally be a forward-backward block.

According to another aspect of the disclosure, there is provided a method of providing a trained artificial neural network adapted to generate beam formed ultrasound signals, the method comprising:
receiving input training data comprising a plurality of processed first electrical signals corresponding to a plurality of first electrical signals received from respective ultrasound transducer elements, wherein each said ultrasound transducer element is adapted to generate a respective said first electrical signal in response to ultrasound received from a location in an object, and wherein the processed first electrical signals correspond to said first electrical signals after application of predetermined delay profiles;
receiving output training data comprising at least one of apodization weights and a plurality of output electrical signals determined by means of an adaptive beam forming method; and
training an artificial neural network by using the input training data and the output training data;
wherein the artificial neural network is adapted to output a beam formed ultrasound signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a predetermined apodization weight, and each said sum is based on less than all of said processed first electrical signals.

In certain embodiments, the artificial neural network is further adapted to determine predicted apodization weights for beam forming the ultrasound signals, to output a plurality of predicted second electrical signals and to generate a predicted beam formed ultrasound signal on the basis of the plurality of predicted second electrical signals. Here, training the artificial neural network includes minimizing a combined mean square error of the predicted apodization weights and the predicted beam formed ultrasound signal.

According to a further aspect of the disclosure, there is provided a computer readable medium carrying instructions which, when the program is executed by a processor, cause the processor to carry out a method as defined above.

According to a further aspect of the disclosure, there is provided a system for beam forming of ultrasound signals, the system comprising:
an input portion for receiving a plurality of first electrical signals from respective ultrasound transducer elements, wherein each said ultrasound transducer element is adapted to generate a respective said first electrical signal in response to ultrasound received from a location in an object;
processor means for processing the first electrical signals and for applying a trained artificial neural network to the processed first electrical signals, wherein the processor means is adapted to:
   process the first electrical signals by applying predetermined delay profiles;
   input the processed first electrical signals into the trained artificial neural network;
   determine apodization weights for beam forming the ultrasound signals; and
   output a beam formed ultrasound signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a respective said apodization weight, and each said sum is based on less than all of said processed first electrical signals; and
an output portion for outputting the beam formed ultrasound signal.

### BRIEF DESCRIPTION OF DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary data-processing pipeline in which the raw received sensor data is processed to obtain an analytic signal, a delay profile is applied and adaptive beamforming of the delayed analytic signal is performed.

FIG. 2 shows an example of a virtual source delay model used to obtain delay profiles for a focused transmission.

FIG. 3 shows one embodiment of a network architecture for performing adaptive beamforming in accordance with the present disclosure.

FIG. 4 shows a comparison between a beamformed image generated from data beamformed in accordance with the present disclosure, an image generated using a conventional minimum variance technique and an image obtained via a beamformer with uniform apodization in accordance with the prior art.

FIG. 5A schematically illustrates a system for ultrasound image reconstruction suitable for the implementation of the architecture of present disclosure.

FIG. 5B schematically illustrates an alternative system for ultrasound image reconstruction suitable for the implementation of the architecture of present disclosure.

FIG. 6 illustrates certain functional operations of an adaptive beamforming method in accordance with the present disclosure.

FIG. 7 illustrates certain functional operations in the training of a network architecture used in adaptive beamforming in accordance with the present disclosure.

### DESCRIPTION OF EXAMPLE EMBODIMENTS

The detailed description set forth below in connection with the appended drawings is intended as a description of various exemplary embodiments of the disclosure and is not intended to represent the only forms in which the present disclosure may be practised. It is to be understood that the same or equivalent functions may be accomplished by different embodiments that are intended to be encompassed within the scope of the invention. Furthermore, terms such as “comprises”, “comprising”, “has”, “contains” or any other grammatical variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprise the element or step.

As an alternative to the reliance upon vast data sets and sufficiently large networks required by conventional deep learning architectures when performing data-adaptive beamforming, application specific architectures with fewer parameters and incorporating prior knowledge can be developed. By incorporating known operators, these networks contain fewer parameters than the architectures associated with a purely data-driven approach and consequently require less training samples. The incorporation of known operators can also improve the accuracy of the model predictions and can ensure a solution that generalises well to unseen data.

The present invention provides a method for adaptive beamforming using a neural network. The network incorporates convolutional layers (i.e. layers performing convolution or cross correlation operations) and known operators to combine multiple observations (from data recorded on different array elements) of real or complex signal data in an optimal way into a single real or complex signal. This provides images with a superior lateral resolution as compared to the Delay and Sum (DaS) beamformer with fixed apodization.

Known operator layers are incorporated to perform sub-array aperture shading and averaging. In the sub-array aperture shading layer, for every sub-array of observations taken from the original input, a weighted sum is performed, the weights are provided by the output of the previous convolutional layer. In the sub-array averaging layer, the average value of the various sub-array weighted sum data is determined to give a single complex signal.

The algorithmic constraint from the MV algorithm, sub-array aperture shading and averaging, is embedded into the network. Consequently, the structural information present in the input is transferred to the output through the final layers which are designed to perform an optimal combination of the input. This constraint aids the ability of the network to generalise to a variety of data outside of the training set.

A sequence of transformations is applied to the input within the neural network to produce the desired output. Unknown parameters associated with this transformation are learned by a gradient descent algorithm which is designed to minimize the errors between the network output and a ground truth obtained by some other method, for instance, a Minimum Variance algorithm. The network may be trained using a combination of simulation data (in-silico), data acquired from experimental phantoms (in-vitro) or from patients in clinical settings (in-vivo).

In certain embodiments, the network utilises, as input, multiple time-delayed samples along an axial dimension (defined as the dimension perpendicular to the face of the ultrasound array) to determine multiple sets of apodization weights along the axial dimensions. The sets of apodization weights are applied to the original observations in the sub-array aperture shading layer of the network.

In certain embodiments, the network performs on sensor channel data (element-space). Alternatively or additionally, the network performs on multiple beamformed channel signals (beamspace), obtained from a set of preliminary beamformers.

Where an axis symmetric array is utilised for imaging, a layer in the network may be incorporated that combines the input data (or a slice of the input data) with a reversed/flipped version of the data across one or more dimensions of the layer input tensor, referred to as a forward-backward block. These layers may be included to provide more accurate determinations of the optimal apodization function.

Whilst a specific example is discussed in relation to 2-dimensional (2D) focused cardiac ultrasound imaging, embodiments are not limited to echocardiography and may also apply to imaging other anatomical features. Embodiments are not limited to focused imaging and may also apply to unfocused imaging. Embodiments are not limited to 2D imaging and may also apply to 3-dimensional (3D) volumetric imaging. Whilst pixel-based delay profiles are discussed herein, embodiments may alternatively or additionally utilise line-by-line delay profiles. In certain embodiments, beamformed data is acquired from single emissions or multiple emissions simultaneously.

To facilitate understanding, the specific example illustrated in the Figures will be described. This is not intended to limit the scope covered in any way. Whilst this embodiment operates in element-space, other embodiments combine beamspace observations. Furthermore, multiple embodiments may be operated in conjunction to combine data in multiple stages.

Consider a linear array of M elements (i.e. an array of sensors suitable for measuring ultrasound echo signals). Each element can convert ultrasound signals received from reflections within the medium (i.e. pressure waves scattered by objects in the medium) into an analog electrical signal. These M analog signals can be amplified and digitised (at a specified sampling rate) in an analog front end (AFE) by analog-to-digital converters (ADCs) to produce M digital signals, or observations, of the region of interest (ROI).

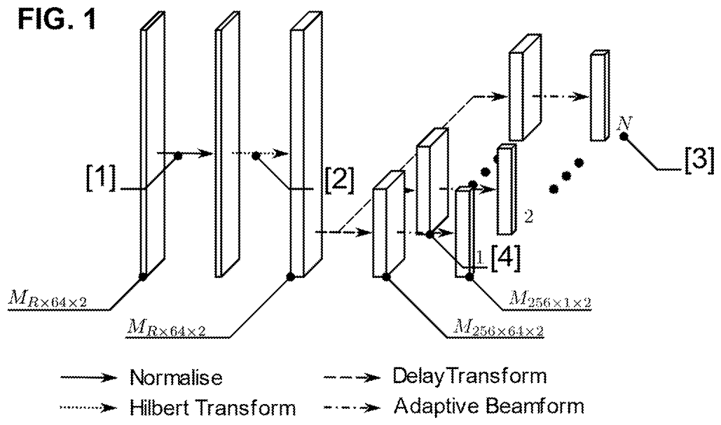

FIG. 1 shows one possible data-processing pipeline in which the digital signals (i.e. samples) corresponding to sensor data are normalised, step [1], prior to obtaining analytic signals via the Hilbert transform, step [2]. Virtual Source delay profiles are applied, step [3] and the delayed data is provided as input to the adaptive beamforming stage, step [4], in accordance with the present disclosure.

A batch size of N, corresponding to the different delay profiles for each line of pixels obtained from a single emission, is illustrated. Each input has an axial dimension, an element dimension, and a dimension corresponding to the real and imaginary components of the analytic signal.

In one example of this embodiment, a 2D transthoracic cardiac array consisting of 64 elements is used to obtain R axial samples from every channel for 64 channels R×64 of recorded data (FIG. 1, step [1]). Other embodiments may use arrays of different geometries such as curvilinear arrays, matrix arrays or those required for intravascular imaging. These arrays may consist of any number of elements and provide any number of observations. In other embodiments, fewer or more samples may be recorded, this will be dependent on the sampling rate of the system, the axial length of the ROI, and the direction of transmission.

At step [1] of the embodiment in FIG. 1, the digital signals (i.e. samples) are normalised between −1 and 1, and the analytic signal is obtained via the Hilbert transform (step [2]). In other cases, the samples may normalised between 0 and 1 before transformation to obtain the analytic signal samples.

The delay profiles used at step [3] of the embodiment are obtained from a virtual source model, in which the focal point is modelled as a spherical virtual source. This virtual source model is described in Kim, C., Yoon, C., Park, J. H., Lee, Y., Kim, W. H., Chang, J. M., Choi, B. I., Song, T. K. & Yoo, Y. M. (2013). Evaluation of Ultrasound Synthetic Aperture Imaging Using Bidirectional Pixel-Based Focusing: Preliminary Phantom and In Vivo Breast Study. IEEE Transactions on Biomedical Engineering, 60, 2716-272.

The delayed signal is input into an adaptive beamforming architecture, step [4],

The initial processing chain may be different to the one described in relation to FIG. 1, the normalisation (stage [1]) may not be present, and the analytic signal may not be required, so that the delay profile may be applied to the samples directly. Delaying the data across the array, step [3], is however a necessary aspect of the signal processing of the input to the architecture in order to compensate for the different path lengths of different transducer elements.

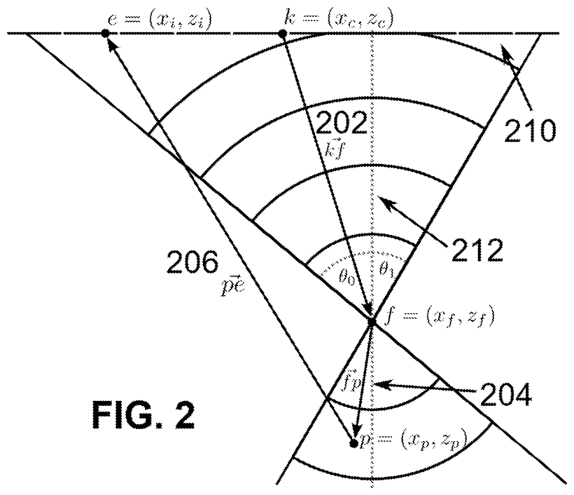

With reference to FIG. 2, elements 202, 204 and 206, the total two-way propagation time from the centre of the array, k, to the point p in the ROI and back to an element e can be described as:

$$t = \frac{1}{c} ( \vert \vec{kf} \vert + \vert \vec{fp} \vert + \vert \vec{p e} \vert )$$

Where c is the speed of sound in the medium and the transmit focal point is selected to be at f. Using these propagation times and, with knowledge of the sampling frequency, a set of delay profiles can be pre-determined and used to gather the appropriate samples.

In FIG. 2, the angles between which the delay profiles are applied can be approximated from the active aperture and the focal point as:

$${θ}_{0} = {tan}^{- 1} ( \frac{{x}_{f} - {x}_{0}}{{z}_{f}} )$$

$${θ}_{1} = {tan}^{- 1} ( \frac{{x}_{f} - {x}_{M}}{{z}_{f}} )$$

Where (x₀, 0) and (x_{M}, 0) correspond to the positions of the first and last elements in the active aperture (FIG. 2). Outside of these limiting angles the pixels are masked.

From FIG. 1, the output of the delay stage represents the input tensor of the architecture (FIG. 1, step [3]). The tensor dimension shape can be described as N×H×W×C, following convention. For the input tensor, N represents the batch size (a set of inputs corresponding to different lateral locations in the medium, where lateral is defined as the dimension parallel to the face of the transducer, i.e. the plane 210 of the element array in FIG. 2), H represents the axial dimension (and consists of samples of multiple axial locations in the medium, where axial is defined as the dimension perpendicular to the face of the ultrasound array, i.e. parallel to axis 212 in FIG. 2), W represents the array element dimension (i.e. the number of elements in the array) and C represents the real and imaginary components of the analytic signal.

In the illustrated embodiment, FIG. 1 step [3], N different delay profiles can be obtained corresponding to N different lateral lines across the ROI from a single emission. Each lateral line in this embodiment consists of the samples, determined by the delay profiles, at 256 axial points, H=256.

In the illustrated example, a software pixel-based delay stage is used to obtain N lateral pixel lines directly from a single emission using a virtual source model. Other examples may utilise unfocused emissions (for instance, plane wave or diverging wave emissions) with corresponding delay profiles or line-by-line delay profiles for focused emissions. Embodiments may beamform batches of data acquired from single emissions or multiple emissions simultaneously using a parallel computing device such as a Graphics Processing Unit (GPU), Field Programmable Gate Array (FPGA), Application Specific Integrated Circuit (ASIC) or another specialist processing unit such as a Tensor Processing Unit (TPU).

A deep learning architecture then combines the M observations into a single beamformed sample for every point in a ROI, in accordance with the present disclosure. The architecture is used to perform the adaptive beamforming stage, illustrated in FIG. 1, step [4]. The network transforms a batch of N lateral lines of channel data into N lateral lines of beamformed data where N can be any number of lines.

As noted above, FIG. 2 illustrates an example of the virtual source delay model used to obtain the delay profiles for a focused transmission. It illustrates how the propagation distance to a point in the region of interest (ROI) and back to the element of interest is approximated.

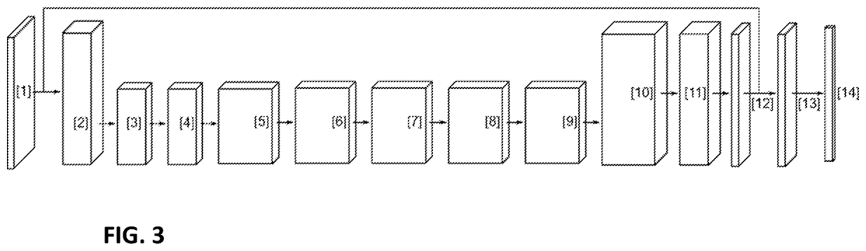

FIG. 3 shows one embodiment of a neural network architecture to perform the adaptive beamforming in accordance with the present disclosure. The network includes convolutional layers together with blocks consisting of known operations. In the embodiment illustrated in FIG. 3, the layers are set out in Table 1.

TABLE 1

| Layer | | | Filter | Filter | | |
|---|---|---|---|---|---|---|
| No. | Layer Type | Output Shape | No. | Size | Stride | Activation |
| 1 | Input | (256, 64, 2) | — | — | — | — |
| 2 | 2D Convolution | (256, 32, 32) | 32 | (5, 5) | (1, 2) | Linear |
| 3 | 2D Max Pool | (128, 16, 32) | — | (2, 2) | — | — |
| 4 | Forward Backward | (128, 16, 32) | — | — | — | — |
| | Combination | | | | | |
| 5 | 2D Convolution | (128, 16, 64) | 64 | (3, 3) | (1, 1) | ReLU |
| 6 | 2D Convolution | (128, 16, 64) | 64 | (3, 3) | (1, 1) | ReLU |
| 7 | 2D Convolution | (128, 16, 64) | 64 | (3, 3) | (1, 1) | ReLU |
| 8 | 2D Convolution | (128, 16, 64) | 64 | (3, 3) | (1, 1) | ReLU |
| 9 | 2D Convolution | (128, 16, 64) | 64 | (3, 3) | (1, 1) | ReLU |
| 10 | 2D Upsample | (256, 32, 64) | — | (2, 2) | — | |
| 11 | 2D Convolution | (256, 32, 32) | 32 | (3, 3) | (1, 1) | ReLU |
| 12 | 2D Convolution | (256, 32, 2) | 2 | (1, 1) | (1, 1) | Linear |
| 13 | Sub-array Aperture | (256, 33, 2) | — | — | — | — |
| | Shading | | | | | |
| 14 | 2D Average Pooling | (256, 1, 2) | — | (1, 33) | (1, 1) | — |

This embodiment requires, as input, the analytic signal from a set of element channels over the region of interest, such as that delivered at step [3] of FIG. 1. For the input tensor, H represents the axial dimension (H=256), W represents the array element dimension (W=64) and C represents the real and imaginary components of the analytic signal (C=2).

The first stage of the network uses a 2D convolutional layer (layer 2), with a stride of (1, 2) and 32 filter channels, followed by a maximum pooling layer (layer 3). This first reduces the element dimension down to the size of the sub-array (W=32). It then forces the network to find a lower dimensional representation of the data. By performing this compression in the first layers of the network, the operations in the subsequent layers are reduced, resulting in a computationally efficient implementation. Whilst in this embodiment the stride was chosen to reduce the sub-array length to a size that is half the size of transducer, other embodiments may select different stride lengths to generate tensor shapes that conform with other sub-array lengths.

In this embodiment, the first known operator occurs in layer 4. Other embodiments may not include such a known operator. This layer takes the output from the maximum pooling layer as input and, under the constraint that at its input C=2 W, partitions the input into two H×W×W matrices of equal dimensions:

$$A = [ \begin{matrix}{A}_{1} \\ {A}_{2}\end{matrix} ]$$

Constructing an exchange matrix/with dimensions W×W, the layer performs a negation and a matrix multiplication between the final two dimensions of its input tensor and the exchange matrix, along the H dimension:

$$B = [ \begin{matrix}{JA}_{1} J \\ J ( - {A}_{2} ) J\end{matrix} ]$$

B is subsequently compounded with the original input:

$$O = A + B$$

Consequently, the layer reverses or flips A₁ and −A₂ along the final two dimensions and combines them with the original input. The first convolutional layer, which is used to transform the input data for the Forward Backward combination layer, utilises a linear activation function, as opposed to a Rectified Linear Unit (ReLU). This is done to preserve the negative components in the output tensor.

Five convolutional layers (layers 5 to 9) are used to transform the output data from the Forward Backward combination layer (layer 4) followed by an up-sampling layer (layer 10) and a further 2 convolutional layers (layers 11 and 12). The upsampling layer (layer 10) transforms the data such that H=256 is the same as the original input size and W=32 is the same as the sub-array length chosen in this embodiment. The final two convolutional layers (layers 11 and 12) transform the data such that C=2 is the same as the original input and represents the real and imaginary components of the complex target weights. Once again, a linear activation function is used for the final convolutional layer (layer 12) to preserve the negative components of these complex target weights.

The final layers (layer 13 and 14) of the network perform the element-wise weighting of the original input with the weights predicted by the final convolutional layer (layer 12). This is achieved by partitioning the original input into two H×W₁×1 tensors representing the real and imaginary components of the analytic signals:

$$A = [ \begin{matrix}{A}_{1} \\ {A}_{2}\end{matrix} ]$$

and, similarly, partitioning the predicted weights, denoted B, into two H×W₂×1 inputs:

$$B = [ \begin{matrix}{B}_{1} \\ {B}_{2}\end{matrix} ]$$

For sub-array weighting and averaging, the constraint on the W dimension is that W₁>W₂. For the embodiment illustrated in FIG. 3, the shape of the delayed input tensor is 256×64×2 and the shape of the apodization weight tensor is 256×32×2.

The complex conjugate of the apodization weights can be determined by negating B₂ which contains the imaginary part of the complex weights, and the partitioned data can be concatenated along the C dimension as:

$${B}^{*} = [ \begin{matrix}- {B}_{2} \\ {B}_{1}\end{matrix} ]$$

Two depthwise convolutions, in which the H dimension is the depth dimension, are used with valid padding to perform the apodization weighting of the delayed input data, one in which the filter is set to B, and one in which the filter is set to B*. The outputs of these convolutions are concatenated along the C dimensions to produce an output with shape H×(W₁−W₂+1)×2. For the embodiment illustrated in FIG. 3, this corresponds to an output tensor (for layer 13) with shape 256×33×2.

The final layer (layer 14) obtains the average value across the W dimension, of its input to obtain the final beamformed output with shape 256×1×2. This is achieved by utilising an averaging pooling layer with pool size equal to (1, W₁−W₂+1).

Combined, these two layers (i.e. layers 13 and 14) can be seen as embedding the known operator:

$$s ( z ) = \frac{1}{M - L + 1} {\sum }_{l = 0}^{M - L} {w ( z )}^{H} {Y}_{l} ( z )$$

Where L=32 is the sub-array length, M=64 is the number of elements in the array, s(z) is the calculated analytic signal as a function of the axial location, w(z)^{H} is the conjugate transpose of the weights as a function of the axial location and Yₗ(z) is the sub-array of observations, the original input to the architecture, as a function of the axial location.

Other embodiments may utilize different filter sizes or strides in the convolutional layers, a different number of convolutional layers and may apply additional compression and expansion through additional pooling and upsampling layers.

Thus, embodiments of the network consist of CNNs and blocks that contain known operators to predict a set of apodization weights. The CNNs utilise multiple observations from multiple axial samples to predict the axial-dependent apodization weights. The convolutional layers in the CNNs may utilise Rectified Linear Unit (ReLU) non-linear activation functions, as they do in the preceding embodiment. To preserve the negative component of some layer outputs, a necessity for some known operator blocks, they may also utilise other activation functions that preserve the negative values such as the linear activation function.

Thus, rather than use a neural network simply to output apodization weights, the network architecture of the present disclosure embeds known beamforming operators to perform the apodization weighting. Whilst in the embodiment discussed above, the known weighting functions are implemented at the end of the neural network architecture, in certain embodiments additional layers may be placed before, interleaved with, or placed after these known operator layers. Thus, apodization weighting is seen to be an intrinsic part of the neural network architecture of the present disclosure. The resulting network architecture does not predict the apodization weights but rather combines the input channel data in an optimal way. This optimal combination is output directly. In certain embodiments, the ground truth optimal combination is determined using a minimum variance algorithm, whereas it may be determined by another algorithm in other embodiments.

In certain embodiments, the known operators incorporate sub-array averaging (as in the embodiment described above). In cases where sub-array averaging is performed, the inputs to the known operator that performs the weighting are not of equal width. For instance, the weights may be half the width of the contributing signals and sub-array averaging is performed. In such cases, all contributing RF signals become the input to the neural network. In most scenarios, said contributing RF signals would be data recorded from every receive element of a transducer. The network may then predict a set of weights to apply to a sub-array. The resulting outputs from this known operator are then averaged in another known operator layer to give an output.

In arrays consisting of many elements, for instance matrix arrays, the contributing RF signals may be a subset of the data recorded on the array. In such a case, multiple embodiments may be operated in conjunction to combine data in multiple stages. In a case consisting of two stages, the contributing RF signals may be combined to produce a single output in the first stage. Multiple outputs from the first stage, obtained from different subsets of the transducer elements, are input into the second stage and optimally combined to produce a single output.

Where minimum variance algorithms are deployed to determine the ground truth optimal combination, sub-array averaging can increase the robustness of the output, something which is of importance in a medical imaging device, at the expense of some loss in resolution.

As noted above, the architecture of the present disclosure introduces other known operators including the forward-backward block. These operators serve to reduce the error in the predicted output in relation to the MV algorithm ground truth. Moreover, these other known operators also act to regularise the training process by reducing the number of learnable parameters and the size of the network which in turn may also improve inference speed. The introduction of known operators may help to ensure the architecture generalises well to previously unseen data, a crucial requirement for medical imaging.

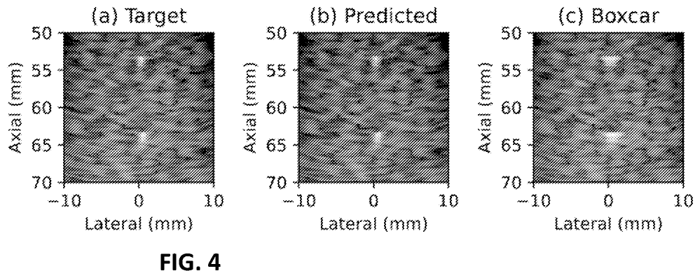

FIG. 4 shows a beamformed image generated from data beamformed using the deep learning beamformer (“predicted image”). An image obtained via a beamformer with uniform apodization (“boxcar image”) is included for reference and comparison.

FIG. 4 illustrates an image generated by the embodiment illustrated in FIG. 3 after envelope detection and log compression are performed. The network architecture in this embodiment was trained using simulated radio frequency (RF) ultrasound signals and a corresponding ground truth (“target image”) obtained via a Minimum Variance (MV) algorithm in which the weights are project onto the signal subspace, referred to as the Eigenspace Based Minimum Variance (EBMV) algorithm.

The minimum variance technique used to obtain the training dataset for the embodiment described above may be understood, in greater detail, as follows:

Consider an array of M elements, the M observations can be described by the column matrix:

$$Y ( t ) = [ \begin{matrix}{y}_{0} t \\ {y}_{1} ( t ) \\ … \\ {y}_{M - 1} ( t )\end{matrix} ]$$

Where yₘ(t)=sₘ(t)+iₘ(t)+nₘ(t) is the analytic signal of each element m at time instance t and contains the desired signal(s), interference (i), and noise (n) components.

As described in Synnevag, J. F., Austeng, A. & Holm, S. (2009). Benefits of minimum-variance beamforming in medical ultrasound imaging. IEEE Transactions on Ultrasonics, Ferroelectrics, and Frequency Control, 56, 1868-1879, a sample covariance matrix, incorporating sub-array averaging and temporal averaging may be estimated according to:

$$\tilde{R} ( t ) = \frac{1}{( 2 K + 1 ) ( M - L + 1 )} {\sum }_{k = - K}^{K} {\sum }_{l = 0}^{M - L} {Y}_{l} ( t - k ) {{Y}_{l} ( t - k )}^{H}$$

Where the notation (·)^{H} denotes the conjugate transpose. The sub-array length L was set to 32 which represents half the aperture size of the phased array probe. The number of temporal samples K was selected such that 9 temporal samples were used in the covariance matrix estimation. These values were chosen to ensure the sample covariance matrix was invertible and to preserve the speckle statistics. FB averaging was used to obtain a more accurate estimate of the covariance matrix, as described in Asl, B. M. & Mahloojifar, A. (2011). Contrast enhancement and robustness improvement of adaptive ultrasound imaging using forward-backward minimum variance beamforming. IEEE Transactions on Ultrasonics, Ferroelectrics and Frequency Control, 58, 858-867. FB averaging is calculated as:

$${\tilde{R}}_{F B} ( t ) = 0.5 ( \tilde{R} ( t ) + J {\tilde{R}}^{*} ( t ) J )$$

Where J is the exchange matrix and the notation (·)* denotes the conjugate. To increase the robustness of the beamformer in the presence of speed of sound estimation errors, diagonal loading was applied. The shrinkage algorithm was used to calculate the loading coefficient automatically, as described in Stoica, P., Jian Li, Xumin Zhu & Guerci, J. (2008). On Using a priori Knowledge in Space-Time Adaptive Processing. IEEE Transactions on Signal Processing, 56, 2598-2602. In this method, shrinkage parameters α and β are calculated based on the received data and the loaded covariance matrix is described as:

$${R}_{a} ( t ) = β ( t ) {\tilde{R}}_{F B} ( t ) + α ( t ) {R}_{0}$$

The shrinkage parameters are determined as:

$$α ( t ) = v \frac{p}{{‖ {\tilde{R}}_{F B} ( t ) - vI ‖}^{2}}$$

$$β ( t ) = 1 - \frac{α ( t )}{v}$$

Where I is the identity matrix and the parameters v and ρ are:

$$v ( t ) = \frac{tr ( I {\tilde{R}}_{F B} ( t ) )}{{‖ I ‖}^{2}}$$

$$ρ ( t ) = \frac{1}{{N}^{2}} {\sum }_{n = 1}^{N} {‖ {Y}_{l} ( q ) ‖}^{4} - \frac{1}{N} {‖ {\tilde{R}}_{F B} ( t ) ‖}^{2}$$

$$Where N = ( 2 K + 1 ) ( M - L + 1 ) and {Y}_{l} ( q ) = {Y}_{l} ( t - k ) .$$

To minimize the variance of the beamformer output, whilst maintaining unity gain at the focal point, a set of apodization weights were calculated using the covariance matrix estimation from Capon, J. (1969). High-resolution frequency-wavenumber spectrum analysis. Proceedings of the IEEE, 57, 1408-1418:

$$w ( t ) = \frac{{{R}_{d} ( t )}^{- 1} a}{{a}^{H} {{R}_{d} ( t )}^{- 1} a}$$

where α is the steering vector, a vector of ones if delays are preapplied. To reduce noise and improve contrast the MVDR weights were projected onto the signal subspace of R_{d}(t) [see Mehdizadeh, S., Austeng, A., Johansen, T. F. & Holm, S. (2012). Eigenspace Based Minimum Variance Beamforming Applied to Ultrasound Imaging of Acoustically Hard Tissues. IEEE Transactions on Medical Imaging, 31, 1912-1921] according to:

$${w}_{EBMV} = {E}_{s + i} {E}_{s + i}^{H} w$$

The signal plus interference subspace was determined automatically based on an estimation of the noise of the received signals. The eigenvalue threshold was set for the sample covariance matrix eigenvectors corresponding to the eigenvalues greater than the scalar described as:

$$\tilde{n} ( t ) = \frac{1}{M} {\sum }_{m = 0}^{M} {\vert {y}_{m} ( t ) - {s}_{D A S} ( t ) \vert}^{2}$$

Where S_{DAS}(t) is the DaS beamformed signal; the average value across the array:

$${s}_{D A S} ( t ) = \frac{1}{M} {\sum }_{m = 0}^{M} {y}_{m} ( t )$$

The output can be described as:

$${s}_{E B M V} ( t ) = \frac{1}{M - L + 1} {\sum }_{l = 0}^{M - L} {{W}_{EBMV} ( t )}^{H} {Y}_{l} ( t )$$

For training the network of above-described embodiment, a suitable optimizer, for example the NAdam optimizer, may be used to optimise for a mean square error (MSE) loss. Batches that contained 16 lateral lines, each with 256 axial samples, were used during training and the data supplied to the network was randomized at each epoch. The network was trained for a maximum of 1000 epochs on simulation data. Early stopping was implemented with a patience of 50. A combined loss was used during training which incorporate the Mean Square Error (MSE) loss of the predicted apodization weights L_{W} and the MSE loss of the final beamformed output L_{S} as:

$${L}_{t o t a l} = λ {L}_{S} + ( 1 - λ ) {L}_{W}$$

where λ is a user defined parameter between 0 and 1. For the network trained in this instance, λ=0.6.

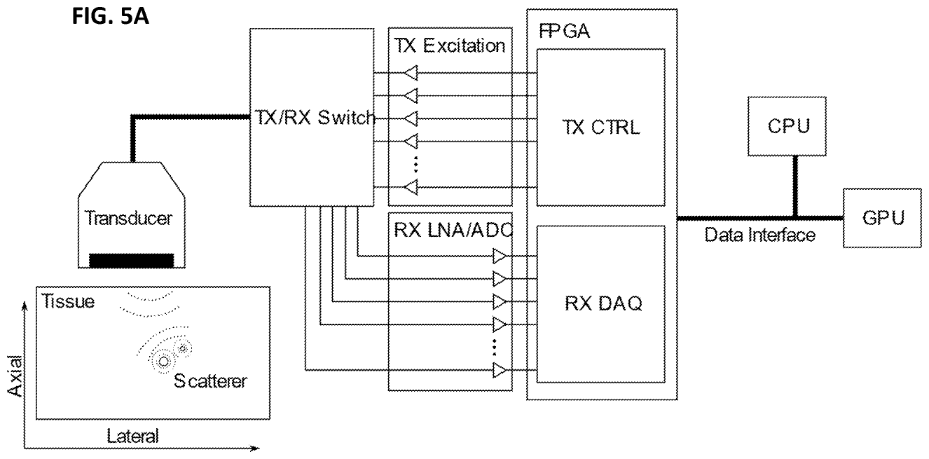

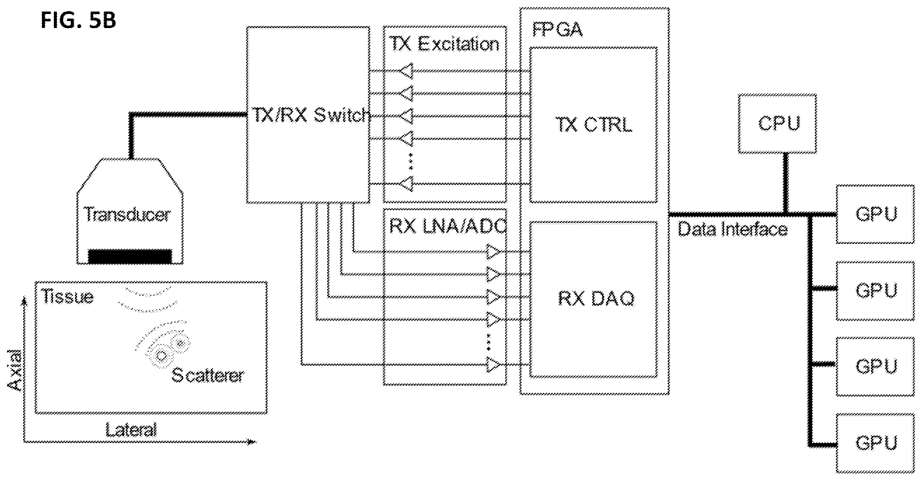

FIG. 5A schematically illustrates a system for ultrasound image reconstruction suitable for the implementation of the architecture of present disclosure. In this system, an imaging transmit sequence is programmed on a CPU. Arbitrary and flexible waveforms can be designed to interrogate a Rol. The transmit parameters are transferred (via a high speed data link) to a Field Programmable Gate Array (FPGA) which controls a series of high voltage transmission circuits (Tx Excitation) in parallel. These are used to excite the piezoelectric elements of a transducer (the “transducer elements”) and generate an ultrasound pressure wave. The high voltage signals pass through a Transmit/Receive switch (TX/RX Switch) which prevents them from damaging the receive electronics.

At the transducer elements, pressure waves scattered by objects (e.g. “scatterer”) are received and converted to (analog) electrical signals.

The TX/RX Switch directs the received electrical signals into a receiver circuit (RX LNA/ADC) including a low noise amplification (LNA) stage, a time gain compensation amplification stage and an analog-to-digital conversion (ADC) stage. The LNA stage is used to amplify the low voltage electrical signals in parallel. This is followed by the time gain compensation amplification stage which is used to amplify the signals with increasing depth. At the ADC stage, the amplified signals are digitised in parallel by high speed analog-to-digital converters (ADCs).

The FPGA is used to control the ADCs and record the samples. These can be transferred, via the high speed data interface, to a GPU where the data is normalised, the analytic signal is obtained via the Hilbert transform and delay transforms are performed to account for the different path lengths of different transducer elements, as described in relation to FIG. 1, for example.

An adaptive beamforming stage is also performed on the GPU. The beamformed data from multiple transmissions may then be envelope detected, undergo log compression and be displayed on a display.

Whilst in FIG. 5A, a single FPGA is shown, multiple FPGAs may be present to control different sub-sections of the transducer array. In such cases, a synchronisation mechanism may be present to synchronise the transmission and reception across these multiple sub-arrays. The GPU may then perform adaptive beamforming on the data recorded via a single FPGA. A further GPU may be used to perform adaptive beamforming in a second stage by taking the partially beamformed data generated by each individual FPGA/GPU in the system before envelop detection and log compression are performed for display.

FIG. 5B schematically illustrates an alternative system for ultrasound image reconstruction suitable for the implementation of the architecture of present disclosure. In this system, multiple GPUs are used to perform the processing. In this case, the data recorded across the elements may be split between a subset of the GPUs (for instance, three GPUs of four available) and partial beamforming may be performed on each GPU. The 4th GPU may be used to perform a second stage of beamforming in which the data obtained from the previous stage is combined. Whilst in this case multiple GPUs are shown, the system may also include multiple CPUs in a similar way and/or an additional FPGA to calculate the analytic signal.

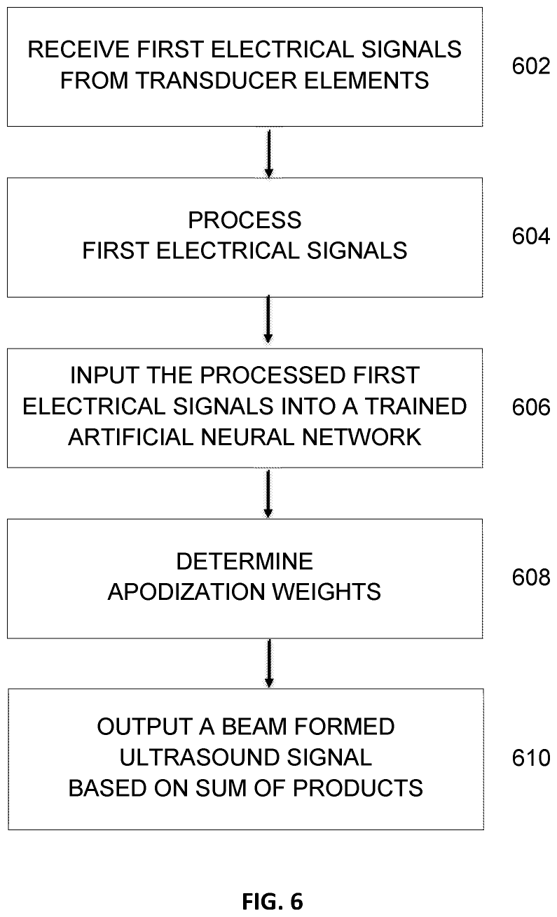

FIG. 6 illustrates certain functional operations of an adaptive beamforming method in accordance with the present disclosure.

At step 602, a plurality of first electrical signals is received from respective ultrasound transducer elements. Each ultrasound transducer element is adapted to generate a respective one of the first electrical signals in response to ultrasound received from a location in an object.

At step 604, the first electrical signals are processed for input into a trained artificial neural network. The processing includes applying predetermined delay profiles to compensate for different path lengths to respective transducer elements. The first electrical signals may also be processed by amplifying the first electrical signals and digitising the amplified first electrical signals. In certain embodiments, the processing of the first electrical signals further includes normalising the digitised first electrical signals and applying a Hilbert transform to the normalised signal.

At step 606, the processed first electrical signals are input into the trained artificial neural network. The network includes a plurality of convolutional layers, and may optionally further include a forward-backward block.

At step 608, the trained artificial neural network determines apodization weights for beam forming the ultrasound signals.

At step 610, the trained artificial neural network outputs a beam formed signal representing scattered ultrasound received from said location in said object on the basis of a plurality of second electrical signals. Each of the second electrical signals is based on a respective sum of products, wherein each said product is a product of a respective first input based on a respective processed first electrical signal and a respective second input based on a respective said apodization weight, and each of the respective sums is based on fewer than all of the processed first electrical signals.

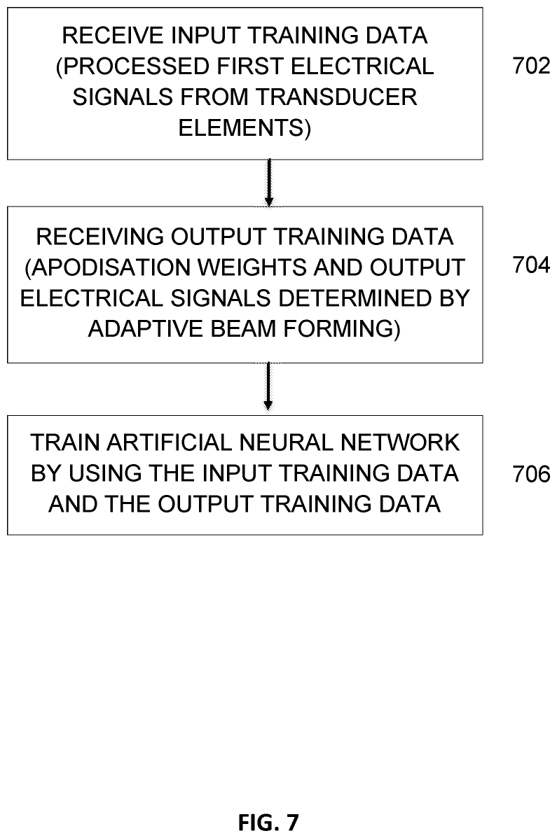

FIG. 7 illustrates certain functional operations in the training of a network architecture used in adaptive beamforming in accordance with the present disclosure.

At step 702, input training data comprising a plurality of processed first electrical signals corresponding to a plurality of first electrical signals received from respective ultrasound transducer elements is received. Each ultrasound transducer element is adapted to generate a respective one of the first electrical signals in response to ultrasound received from a location in an object and the processed first electrical signals correspond to said first electrical signals after application of predetermined delay profiles.

At step 704, output training data is received. This output training data comprises apodization weights and a plurality of output electrical signals determined by means of an adaptive beam forming method, such as the MV technique outlined above.

At step 706, the artificial neural network is trained using the input training data and the output training data.

The description of the various embodiments of the present disclosure has been presented for purposes of illustration and example, but is not intended to be exhaustive or to limit the invention to the forms disclosed. It will be appreciated by those skilled in the art that changes could be made to the embodiments described above without departing from the broad inventive concept thereof.

Further particular and preferred aspects of the present invention are set out in the accompanying independent and dependent claims. It will be appreciated that features of the dependent claims may be combined with features of the independent claims in combinations other than those explicitly set out in the claims.

1. A method of generating beam formed ultrasound signals, the method comprising:
receiving a plurality of first electrical signals from respective ultrasound transducer elements, wherein each said ultrasound transducer element is adapted to generate a respective said first electrical signal in response to ultrasound received from a location in an object;
processing the first electrical signals, said processing including applying predetermined delay profiles;
inputting the processed first electrical signals into a trained artificial neural network, the trained artificial neural network including a plurality of convolutional layers;
determining, in the trained artificial neural network, apodization weights for beam forming the ultrasound signals; and
outputting, from the trained artificial neural network, a beam formed signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a respective said apodization weight, and each said sum is based on less than all of said processed first electrical signals.

2. A method according to claim 1, wherein a plurality of said second electrical signals is based on a respective plurality of said first electrical signals received from said location in the object at different times.

3. A method according to claim 1, wherein processing the first electrical signals further includes amplifying the first electrical signals and digitising the amplified first electrical signals.

4. A method according to claim 3, wherein processing the first electrical signals further includes normalising the digitised first electrical signals and applying a Hilbert transform to the normalised signal.

5. A method according to claim 1, wherein the trained artificial neural network further includes at least one beamforming operator layer.

6. A method according to claim 5, wherein said at least one beamforming operator layer is a forward-backward block.

7. A method of providing a trained artificial neural network adapted to generate beam formed ultrasound signals, the method comprising:
receiving input training data comprising a plurality of processed first electrical signals corresponding to a plurality of first electrical signals received from respective ultrasound transducer elements, wherein each said ultrasound transducer element is adapted to generate a respective said first electrical signal in response to ultrasound received from a location in an object, and wherein the processed first electrical signals correspond to said first electrical signals after application of predetermined delay profiles;
receiving output training data comprising at least one of apodization weights and a plurality of output electrical signals determined by means of an adaptive beam forming method; and
training the artificial neural network by using the input training data and the output training data;
wherein the artificial neural network includes a plurality of convolutional layers and at least one beamforming operator layer; and
wherein the artificial neural network is adapted to output a beam formed ultrasound signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a predetermined apodization weight, and each said sum is based on less than all of said processed first electrical signals.

8. A method as claimed in claim 7, wherein the artificial neural network is further adapted to determine predicted apodization weights for beam forming the ultrasound signals, to output a plurality of predicted second electrical signals and to generate a predicted beam formed ultrasound signal on the basis of the plurality of predicted second electrical signals; and
wherein training the artificial neural network includes minimizing a combined mean square error of the predicted apodization weights and the predicted beam formed ultrasound signal.

9. A computer program comprising instructions which, when the program is executed by a processor, cause the computer to carry out a method according to claim 1.

10. A system for beam forming of ultrasound signals, the system comprising:
an input portion for receiving a plurality of first electrical signals from respective ultrasound transducer elements, wherein each said ultrasound transducer element is adapted to generate a respective said first electrical signal in response to ultrasound received from a location in an object;
processor means for processing the first electrical signals and for applying a trained artificial neural network to the processed first electrical signals, the neural network including a plurality of convolutional layers and at least one beamforming operator layer, wherein the processor means is adapted to:
process the first electrical signals by applying predetermined delay profiles;
input the processed first electrical signals into the trained artificial neural network;
determine apodization weights for beam forming the ultrasound signals;
output a beam formed signal representing scattered ultrasound received from said location in said object on the basis of a plurality of second electrical signals, wherein each said second electrical signal is based on a respective sum of products, wherein each said product is a product of a respective first input based on a respective processed first electrical signal and a respective second input based on a respective said apodization weight, and each said sum is based
on less than all of said processed first electrical signals; and
an output portion for outputting the beam formed ultrasound signal.
